(19) United States
(12) Patent Application Publication
(10) Pub. No.: US 2017/0016826 A1
(43) Pub. Date: Jan. 19, 2017

(54) Invisible Inimitable Identity, Provenance, Verification and Authentication 7,70 Identifier System

(71) Applicant: Roger Dale Norton, Independence, MO (US)

(72) Inventor: Roger Dale Norton, Independence, MO (US)

(73) Assignee: Invisible Sentry LLC, Independence, MO (US)

(21) Appl. No.: 14/802,397

(22) Filed: Jul. 17, 2015

(51) Int. Cl. G01N 21/64; C09K 11/77

(52) U.S. Cl. CPC G01N 21/6408; G01N 21/6428; C09K 11/7792; C09K 11/7774; C09K 11/7771; C09K 11/7789; G01N 2201/062

(57) ABSTRACT

The Invisible Inimitable Identity, Provenance, Verification and Authentication 7,70 Identifier System is an invisible or visible identifying embodiment having multiple machine readable emission output wavelengths and phosphorescence decay lifetimes generated from crystals contained in the embodiment when subjected to an incident energy source(s), the spatial distribution of the crystals limited only to the embodiment boundary. Comparison of the resulting spectral information histogram, using a preselected percentage of the decay lifetimes, against a database containing the embodiment's pre-established information verifies an item's identity and validates it as authentic. The system provides real-time verification for OEM parts and other items rapidly determining if the part or item is, in fact, an actual OEM item thus providing compliance to SAE Aerospace Standard AS6081. The 7,70 Identifier System provides a cost effective means of counterfeit part avoidance providing in excess of one billion individual unique identities.

### CROSS REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

Technical Field

The disclosed invention relates to the field of invisible identity marking, verification and authentication, security, anti-theft and item tracking systems and methods for unique identification for OEM products and other identity purposes using optical measurements from phosphorescent microparticles.

Description of Related Art

Microparticles have been used since the 1970's to mark a product for identity and for authentication. Most marking methods are employed in the form of alphanumeric signs, patterns, bar codes or layers of uniquely engineered microparticles. Usually the mark is visible or otherwise machine readable for comparison to previously collected marking information for purposes of article tracking or authenticity validation. Pertinent prior art relevant to this invention are those disclosing spectral data us as unique identifiers. U.S. Pat. No. 4,053,433 describes a method of marking a substance with microparticles encoded with an orderly sequence of distinguishable colored segments that can be decoded with use of a microscope or other magnifying device. U.S. Pat. No. 4,767,205 discloses an identification method involving an identification code based upon a selected number of groups of microparticles, wherein each group is made of highly uniform microparticles of substantially the same uniform size, shape and color with the specific combination of size, shape and color in one group not being repeated in any other group. U.S. Pat. No. 6,432,715 teaches use of microparticles containing one or more layers of colored or dyed layers whereby the plurality of colored layers provides a code for identification. U.S. Pat. No. 6,647,649 discloses a process for marking an article by applying thereto a tag, which comprises a plurality of microparticles having two or more distinguishable marker layers corresponding to a predetermined numeric code. U.S. Pat. No. 7,597,961 teaches of emission of a first taggant causing an alteration to the emission in a second adjacent taggant by adding a polymer coating to the first taggant. The emission of the second taggant is predicted based upon the polymer coating formulation thus when machine read creates an identity. U.S. Pat. No. 8,110,407 teaches of a semiconductor microparticle assembly comprised of at least three kinds of fluorescent semiconductor mircroparticles with an average particle size of 1-10 nm having the same chemical composition, a different average particle size and a different emission maximum wavelength in the emission spectra and utilized as a fluorescent marker.

| Pat. | Issue Date | Inventor |
|---|---|---|
| 8,975,597 | Mar. 10, 2015 | Van Asbrouck, et al |
| 8,866,106 | Oct. 21, 2014 | Van Asbrouck |
| 8,822,954 | Sep. 2, 2014 | Li, et al |
| 8,110,407 | Feb. 7, 2012 | Tsukada, et al |
| 7,912,653 | Mar. 22, 2011 | Scher |
| 7,837,117 | Nov. 23, 2010 | Finnerty, et al |
| 7,815,117 | Oct. 19, 2010 | Tuschel |
| 7,687,271 | Mar. 30, 2010 | Gelbart |
| 7,597,961 | Oct. 6, 2009 | Maruvada, et al |
| 7,571,856 | Aug. 11, 2009 | Lo |
| 7,401,817 | Jul. 22, 2008 | Muller-Rees, et al |
| 7,055,691 | Jun. 6, 2006 | Safian |
| 6,647,649 | Nov. 18, 2003 | Hunt, et al |
| 6,610,351 | Aug. 26, 2003 | Shchegolikhin, et al |
| 6,455,157 | Sep. 24, 2002 | Simons |
| 6,432,715 | Aug. 13, 2002 | Nelson, et al |
| 6,221,279 | Apr. 24, 2001 | Strand |
| 6,138,913 | Oct. 31, 2000 | Cyr, et al |
| 5,760,384 | Jun. 2, 1998 | Itoh, et al |
| 5,703,229 | Dec. 30, 1997 | Krutak, et al |
| 4,767,205 | Aug. 30, 1988 | Iura, et al |
| 4,131,064 | Dec. 26, 1978 | Ryan, et al |
| 4,053,433 | Oct. 11, 1977 | Lee |
| Application | Application Date | Inventor |
| 20140055824 | Feb. 27, 2014 | Tremolada, et al |
| 20130048874 | Feb. 28, 2013 | Rapoport, et al |
| 20130015369 | Jan. 17, 2013 | Rapoport, et al |
| 20120242460 | Sep. 27, 2012 | Swiegers, et al |
| 20120104278 | May 3, 2012 | Downing, et al |
| 20100277805 | Nov. 4, 2010 | Schilling, et al |
| 20100200649 | Aug. 12, 2010 | Callegari, et al |
| 20090008924 | Jan. 8, 2009 | Ophey, et al |
| 20070246932 | Oct. 25, 2007 | Heine, et al |
| 20050112360 | May 26, 2005 | Berger, et al |
| 20040112962 | Jun. 17, 2004 | Farrall, et al |

The common theme among prior marking inventions using microparticles or microcrystals is use of a plurality of particles' emitting electromagnetic wavelengths or their associated visible colors whereby combinations of the colors or combinations of only the emitting wavelengths thereof create unique identifiers as sufficient evidence of identity, whether these particles are layered in a film, spherical layers or adjacent color markings on a microparticle. Increasingly counterfeiters have developed methods to observe and copy these color and wavelength specific codes and apply them to counterfeit products. Other more secure methods involve use of actual biological species DNA for product identity. DNA methods require several hours, if not days, to validate authenticity.

The invention of this disclosure is distinguished from prior art by addition of a layer of security in the identity scheme using rare earth elements wherein three or more phosphorescent particles are concealed in an embodiment, and the combination of both their wavelengths and decay lifetimes are used in the identity scheme; further, only a user selected portion of the decay lifetime is used.

### BACKGROUND OF THE PROBLEM

The International Chamber of Commerce commissioned a study conducted by Frontier Economics, London to examine the global economic and social impacts of counterfeiting and piracy. The February 2011 report estimates 2015 value of counterfeit and pirated products to be as much as $960 billion every year. No current formalized report updates the current status. On May 6, 2014 the Government amended DFARS 246.870-2, Detection and Avoidance of Counterfeit Electronic Parts, requiring contractors that are subject to the Cost Accounting Standards (CAS) and that supply electronic parts or products that include electronic parts and their subcontractors that supply electronic parts or products that include electronic parts, are required to establish and maintain an acceptable counterfeit electronic part detection and avoidance system. The system criteria includes in pertinent part methodologies to identify suspect counterfeit electronic parts and to rapidly determine if a suspect counterfeit electronic part is, in fact, counterfeit. Standards such as SAE Aerospace Standard AS6081 have also been developed to monitor and certify that systems and methods can meet the Government requirements.

To combat critical supply chain infrastructure vulnerability from emerging threats of electronic part proliferation, novel and covert methods of electronic item unique identity and control for authoritative life-cycle original equipment manufacturer (OEM) identity and authentication are urgently needed, especially for critical materiel susceptible to counterfeiting.

### BRIEF SUMMARY OF THE INVENTION

The Invisible Inimitable Identity, Provenance, Verification and Authentication 7,70 Identifier System invention provides real-time validation and verification for electronic parts and any other manufactured item rapidly determining if the part or item is, in fact, an actual OEM item. The 7,70 Identifier System provides compliance to SAE Aerospace Standard AS6081 with in excess of one billion covert identities for OEM parts and other products, each unique and incapable of being reverse engineered and allowing for verification of authenticity within seconds. The system comprises an invisible or visible identifying embodiment having machine readable optical characteristics whereby a selected portion of three or more phosphorescence decay lifetimes together with their respective centered wavelengths when assayed for optical measurements are compared as a data histogram against a database containing the pre-established embodiment's stored spectral information thus validating the item's identity.

### Advantageous Effects of the Invention

The 7,70 Identifier System provides a cost effective means of counterfeit part avoidance providing in excess of one billion invisible or visible identities for OEM parts and other products, each unique and incapable of being reverse engineered or duplicated.

### BRIEF DESCRIPTION OF THE SEVERAL VIEWS OF THE DRAWING(S)

FIG. 1 Depicts an example rare earth crystalline structure; the example depicts a Europium crystal which is cube shaped; most rare earths are octagon shaped crystal growth.

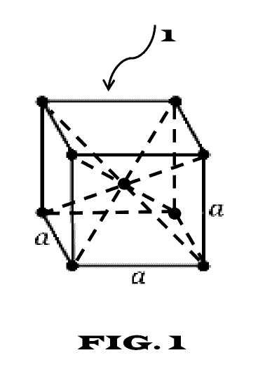

FIG. 2 Depicts an example of a compound structure doped with the rare earth Europium; the compound shown in the example is glass.

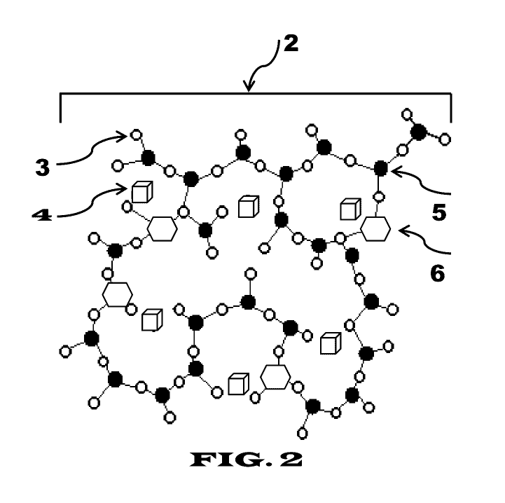

FIG. 3 Depicts the physics symbol for photons; represents thousands to tens of thousands photons.

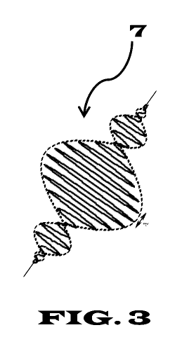

FIG. 4 Depicts the invention embodiment and process for obtaining optical data for identity; beginning with the embodiment containing three or more populations of a crystal, excitation from an example LED source; rise time to intensity of emission, centered wavelength determination and photon count at intensity, decay of emission back to steady state and multiple photon counts during decay lifetime; transmittal of data to compare to database.

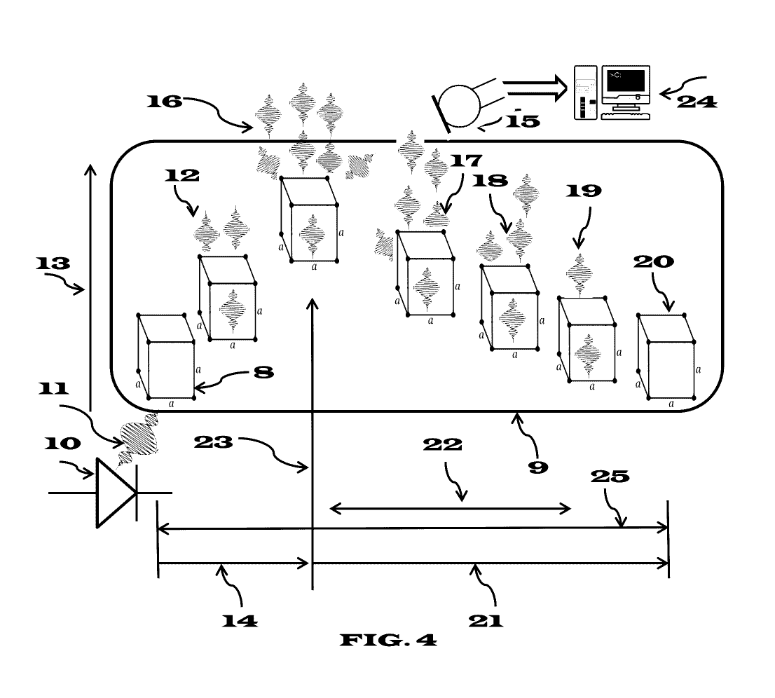

FIG. 5 Depicts an example of seven like crystal populations within a four segment non-contiguous marking, each portion containing one or more of the like-crystal populations.

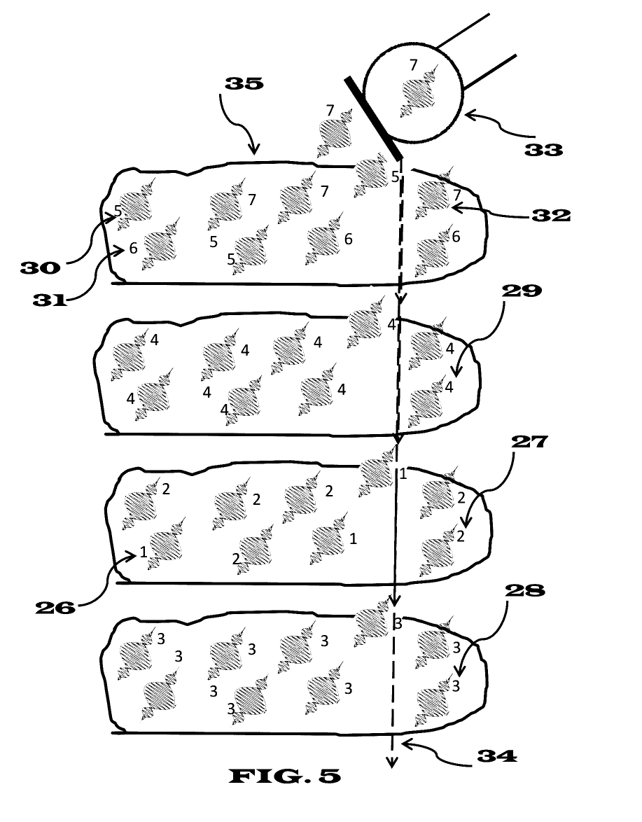

### DETAILED DESCRIPTION OF THE INVENTION

The Invisible Inimitable Identity, Provenance, Verification and Authentication 7,70 Identifier System provides real-time validation and verification for manufactured electronic parts and other items rapidly determining if the part or item is, in fact, an actual OEM item. The 7,70 Identifier System provides a means of counterfeit part avoidance providing in excess of one billion individual unique identities. It is an invisible or visible identifying embodiment (9) having machine multiple readable photons (7) emission output wavelengths and phosphorescence decay lifetimes generated from the embodiment (16) when subjected to pulsed incident energy source(s) (10). Comparison of the resulting optical measurement data histogram against a pre-established database containing the embodiment information verifies an item's identity and validates it as authentic. The 7,70 Identifier System uses three or more phosphorescence crystals' spectral decay lifetimes' data in combination with their peak emission wavelengths' (23) data to establish an individual identity for each embodiment, with only a selectable percentage (22) of the photon decay (17, 18, 19) lifetimes is used for the naming convention scheme making the identity universally unique and incapable of being reverse engineered;

Engineered phosphorescence microcrystals are built using various host materials and at least one (1) of the rare earth element crystals to emit unique photon optical responses centered at specified electromagnetic radiation wavelengths whereby, when subjected to a pre-determined input energy (11) source of a different wavelength, each synthesized microcrystal is engineered to emit a different phosphorescence decay time. The engineered microcrystals are combined in an embodiment whereby three or more (26, 27, 28, 29, 30, 31, 32) crystals provide a set from which unique optical information and therefore identity of the embodiment is established. When smaller particles less than approximately 300 nm are used, the small microcrystal particle size of the embodiment ‘identifier’ can be covertly applied on or within the surface of an electronic part or other manufactured item with no immediate evidence of its presence. Application can also be accomplished via microcrystal distribution throughout various media, binders, inks, coatings or films.

The engineered crystalline structures provide unique combination formulations of highly complex, inimitable optical codes. The optical code information can be retrieved using production and/or field devices (15) and transmitted to secured comparison databases (24) for identity and OEM source comparison and validation. Hundreds of unique compound crystalline structures can be used for 7,70 Identifier System.

The rare earth phosphorescent crystals used in the invention are chosen from any of the Lanthanides; Lathanum (La), Cerium (Ce), Prseodynium (Pr), Neodymium (Nd), Promethium (Pm), Samarium (Sm), Europium (Eu), Gadolinium (Gd), Terbium (Tb), Dysprosium (Dy), Holium (Ho), Erbium (Er), Thulium (Tm), Ytterbium (Yb), or Lutetium (Lu); or from the Transition Metals: Scandium (Sc) or Yttrium (Y). The use of rare earths is not intended to be limiting. Gold (Au) and other metals in various compounds and under certain conditions also exhibit phosphorescence and can be used.

The host materials available for syntheses and doping of the rare earths and other metals are a significant listing. The invention prove-out used the following crystals: SrAlO4:Eu,Dy; Gd2O2S:Tb; Y2Si4N6C:Ce; and Gd2O2S:Eu.

The invention prove-out used 1 percent of each of the four prove-out crystals in a small quantity of a two part epoxy, specifically HARDMAN® 04001 Red Double Bubble® Extra Fast Setting Epoxy NSN: 8040-00-092-2816 from Royal Adhesives and Sealants, L L C. 2001 W. Washington Street, South Bend, Ind. 46628.

The embodiment was then inserted in a cuvette and installed in a Horiba Easy Life™X to determine lifetime measures. After subjecting the embodiment to an incident light source emitting wavelength 390 nm spectral measurements were obtained at the following centered emission wavelengths: SrAlO4:Eu,Dy at 504 nm; Gd2O2S:Tb 537 nm; Y2Si4N6C:Ce 572 nm; and Gd2O2S:Eu 628 nm.

The spectral measurement for decay lifetimes were truncated to 50 percent of normal lifetime values and measurements were read at values 504 nm,85 ms; 537 nm,120 ms; 572 nm,140 ms and 628 nm,260 ms.

On a Hewlett-Packard Pavilion m7 containing a CORE™ 17 processor and containing Microsoft® Office Microsoft Excel 2010 a look-up table was prepared in Excel as an example listing numbers 1, 2, 3, 4, 5, 6, 7, 8, 9, and 10 in cells horizontally; and installing numbers 1,2,3,4; 1,2,3,5; 1,2,3,6; 1,2,3,7; 1,2,3,8; 1,2,3,9; 1,2,3,10; 1,3,4,5; 1,3,4,6 and so on until there were 210 completed cells with no cell having repeated the same set of integers. The value 504 nm,85 ms was cross-referenced to the number 4; 537 nm,120 ms was cross-referenced to the number 6; 572 nm,140 ms was cross-referenced to the number 7 and 628 nm,260 ms was cross-referenced to the number 10 thus making, via the naming convention, the identity of the embodiment in whole numbers 4, 6, 7, 10. Of the 210 possible combinations containing a subset of 4 from a population set of 10, upon obtaining the optical measurement histograms and comparing it to the database, the look-up find request selected the cell containing the whole numbers 4, 6, 7, 10 as the validated number for the identity.

As elements in the subset increase and the population set increases, the available combinations grow exponentially. To determine the number of combinations available for any subset of a larger population set, in Excel® one only needs to click on unused cell and type in=COMBIN(number of population, number of subset). As of the date of this invention application the inventor has created in excess of one million combinations of seven subset numbers from a population of seventy. As needed the creation of additional combinations will be added to the database as the possible number of combinations available using a subset of seven from a population of seventy=COMBIN(70,7) is 1,198,774,720.

Lifetime of the phosphorescence process (25) can be characterized using three time domains: 1) moment of application of incident radiation for excitation to maximum intensity (13) is the phosphorescence rise time (14); 2) persistence of emission at peak intensity after removal of source radiation [duration at peak intensity]; and 3) time from cessation of peak intensity value through reduction of that value to return to steady state (20) at which time photons are no longer released from the material [decay time] (21). The centered wavelength is determined at peak intensity (23). The decay lifetime measurement is the time domain portion of phosphorescence lifetime and together with the centered wavelength the two values are used for the 7,70 Identifier System invention.

The development of nanosecond light sources based on light emitting diodes (LEDs) (10) has led to the creation of a variety of portable lifetime instruments. An all solid-state, filterless, and highly portable light-emitting-diode based time-domain fluorimeter (LED TDF) can be used for the measurement of nanosecond lifetimes using LED based excitation. For crystals tested the Horiba Easy Life™X was used. LED sources available for the Horiba Easy Life™X provide excitation wavelengths (stated in nanometers): 266, 280, 297, 310, 340, 368, 385, 403, 407, 432, 444, 456, 486, 510, 518, 572, 633, 649, 649, and 667. Other Excitation Laser Sources for up-converting crystals with lower frequency absorption requirements include JDSU 3000 series 660 mW Fiber Bragg grating stabilized 976+/−1 nm pump module (PN 30-7602-660); Edmund Optics fiber laser 976 nm 450 mW (PN NT62-688); Newport LD Module, 980 nm, 220 mW, CW—(Model: LQC980-220E); and among others a fiber-optically coupled USB4000 fluorescence spectrometer (Ocean Optics, USA) using an external continuous-wave laser centered at ˜980 nm as the excitation source also determines wavelengths. Many other manufacturers offer similar incident excitation energy sources through and inclusive of the near and far infrared wavelengths.

Among materials that produce luminescence or phosphorescence are rare earth elements, fluorophores, phosphorescent compounds such as zinc sulfide, sodium fluorescein, or other similar materials. The host materials are typically oxides, nitrides and oxynitrides, sulfides, selnides, halides or silicates of zinc, cadmium, manganese, aluminum, silicon or various rare earth metals. The activators prolong the emission time (afterglow). In turn, other materials (such as nickel) can be used to quench the afterglow and shorten the decay lifetime of the phosphor emission characteristics. For the 7,70 Identifier System invention rare earths exhibiting phosphorescence are used as individual crystals or in compounds doped with the rare earths and installed in the embodiment(s). Rare earths are preference in the invention for their persistent decay lifetimes (21), their ability to allow for tuning of lifetimes in crystals during synthesis and generally the long term stability of the identifier.

Phosphorescent rare earth microcrystals ranging in size from 10 nanometers-500 microns in size having specific engineered emitting wavelengths and decay lifetimes are used in the embodiment(s) to provide the individual unique identities described in this invention.

The microcrystals' individual emissions of photons establish the machine readable wavelengths; their intensity value defines the machine readable (15) photon population (16, 17, 18, 19) and the decay of that value provides the measurement of the resultant phosphorescence decay lifetime (21). When placed in a specific combination set with other similar but different unique emitting microcrystals; together subsequently presented with incident electromagnetic energy at a wavelength(s) the crystals will absorb (selected to initiate an excited state in the resident particles), the machine readable spectral wavelengths in combination with a portion their decay lifetimes provide an invisible, inimitable, unique identity whereby when read and compared to a database authenticity is confirmed. A specific combination in one group is not repeated in any other group, the combinations therefore are limited only to the number of unique particles in the population. For example, a combination of seven particles from a group of seventy, and the chosen seven are not repeated, generates one billion one hundred ninety eight million seven hundred seventy four thousand seven hundred twenty unique, individual combinations.

The radiative emission of light (12) from a molecule (8) after excitation has a multiparameter nature. The objective of a measurement is therefore to gain information concerning as many parameters as possible. A steady state measurement of the phosphorescence emission (intensity vs wavelength) gives an average and also relative representation. The phosphorescence lifetime gives an absolute (independent of concentration) measure and allows a dynamic picture of the phosphorescence to be obtained, factors that explain the appeal of this form of measurement.

The microcrystals are designed to emit specified unique electromagnet radiation responses centered at a desired wavelength when subjected to a standardized input source of a different specified frequency through an up-conversion and/or down-conversion of energy. Various timing and temperature processes provide synthesis control whereby optical properties of the rare earth crystals are tuned for various but precise decay times and spectral wavelength electroluminescent responses. Due to the small particle size the microcrystal ‘identifier’ it can be covertly applied on or within the surface of an electronic part or other marketable item with no visible evidence of their presence. Combinations of the engineered microcrystals are used to uniquely provide an identity to a part.

The present invention wherein the embodiment comprises three or more phosphorescent particles, and when probed for an optical response, radiative excitation results from application of intermittent or gated incident laser (coherent) light, LED source(s) or other light source(s), the number of sources and their applied energy are sufficient to create photon emission intensity upon relaxation whereby phosphorescence is exhibited and photons released from each particle within the plurality are machine readable;

The intermittent or pulsed radiative excitation of the phosphorescent particles at steady or ground state (8) and subsequent relaxation of the particles to steady or ground state (20) emits photons at a rate consistent with the input energy power until excitement is saturated resulting in maximum release of photons to obtain its maximum luminescent intensity (13) sufficient for a machine to detect the centered emitting spectral wavelength; said wavelength preferably, but not necessarily, an electromagnetic radiation wavelength or frequency within the human safe visible spectrum, wherein the typical human eye responds to wavelengths from about 390 to 700 nm, corresponding in terms of frequency to a band in the vicinity of 430 to 790 THz, terahertz equals 10̂12 Hz, one hertz meaning “one cycle per second,” whereby the spectral peak wavelengths data from the plurality of particles are a portion of the identification information.

The engineered crystalline structures provide unique combinations of highly complex, inimitable optical codes, the information of which can be retrieved using production and/or field devices and transmitted to secured comparison databases for identity and OEM source validation. For example, the compound crystalline structure “glass” (2) contains molecules of oxygen (3), silicon (5) and titanium (6), but can also be doped with phosphorescent rare earths such as Europium (4). Optical parameters can be read with lab, production and field equipment using the described equipment. Parts can be visibly or invisibly marked for its identification, source and time of manufacture. Multiple embodiments (35) may be used in the identifying mark whereupon application the mark is dissected into multiple embodiments including various phosphorescent crystals, one or more in each embodiment (26, 27, 28, 29, 30, 31, 32) in a distinguishable set of individual embodiment marks in a non-contiguous format of asymmetric three dimensional design or a symmetric design such as a barcode design, wherein photon emission from each mark can be machine read (33) omnidirectional or across the marks (34) and the combination of measured decay lifetime values machine read from all marks within a predetermined area one half millimeter or greater are used for final data identity comparison; the part can be marked at the source manufacturer using the applied code for inventory control and future authentication; the 7,70 Identifier System providing near one billion two hundred million unique identities, each incapable of reverse engineering or duplication.

I claim:

1. An identity, verification and authentication system, an embodiment comprising a subset of three or more from a population of more than three inorganic phosphorescent crystals having different optical measurements, installed within an object's structure or in a suitable compound or binder upon the surface of the object, from which the subset of crystals when assayed for optical characteristics after application of incident energy source(s) conducive to their acceptable absorption and upon the energy source(s) removal, the crystals luminesce whereupon the subset combination of like crystals' and different crystals' emitting wavelengths' values together with their respective decay lifetimes' values are data collected in histograms used to establish a unique identity scheme, thereafter the decay lifetime values are multiplied by a user selected percentage of the measured decay lifetime value to be combined with the particle wavelength data to establish an identity.

2. The invention of claim 1 is an embodiment comprised of a subset of three or more, preferably seven inorganic phosphorescent crystals from a population set of more than three, preferably seventy each having different optical measurement after excitation.

3. The invention of claim 2 comprises an embodiment with a subset of crystals, wherein more than one like crystal may be present in the embodiment for each different crystal represented in the subset.

4. The invention of claim 1 comprises phosphorescent crystals that are dispersed within an embodiment with or without spatial pattern, limited only to the retaining capability of the embodiment boundary.

5. The invention of claim 1 comprises a subset of different inorganic crystals that exhibit phosphorescence upon radiative excitation have machine detectable emission wavelengths and decay lifetimes.

6. The machine detectable emission wavelengths and decay lifetimes data of claim 5 for each crystal, or alternately when more than one like crystal is represented in the subset, each group of like crystals in the subset, the optical measurement data are collected and when the data is combined in a histogram for each or like group in the said subset, the subset's histograms in combination are a set of quantitative values which become the embodiment's, and correspondingly, the object's individual unique identity naming convention.

7. The emission decay lifetimes of claim 6 after collection in the histogram are further secured by selecting an arbitrary percentage of the measurement before assigning it as a discriminator in the database containing values for assigned identities.

8. The different inorganic phosphorescent crystals of claim 1 are described as some crystals of the population upon radiative excitation, emit photons at dissimilar peak emission wavelengths having similar decay lifetimes, and/or others emit at similar peak wavelengths having dissimilar decay lifetimes, and/or others emit at dissimilar peak wavelengths having dissimilar decay lifetimes.

9. The crystal of dissimilar peak emission wavelength of claim 8 is described as one, after performing an assay to determine optical measurements, the wavelength at emission intensity peak after pulsed radiative excitation when compared to another analyzed in the same manner is distinguished as different or dissimilar from any other by a minimum two or more nanometers on the electromagnetic spectrum within the near ultraviolet, near infrared or far infrared regions, preferably the visible spectrum of these.

10. The particle dissimilar decay lifetime of claim 8 is described as the mean phosphorescence decay lifetime of photon emission of one particle being separated ten or more microseconds from the mean decay lifetime of any other unlike particle in the population of particles when the pulsed incident energy source(s), photon counting beginning criteria and end criteria are consistent among analyses of the target crystals within a subset.

11. The invention of claim 1 comprising three or more, preferably seven from a population set of more than three, preferably seventy different inorganic phosphorescent crystals, the subset as a collective total of crystals, or groups of like crystals, are not repeated for any other identity embodiment, for at least one different phosphorescent crystal is selected from the population to be used in the embodiment defining the next unique identification, having replaced one from the previous subset.

12. The non-repeating subset of claim 11 whereby individual particles or groups of like particles are installed in the embodiment, upon optical measurement of the embodiment the wavelength and decay lifetime emission data are collected for each in histograms and the resulting combination of histograms collectively forms a data set used to establish a unique identity and when compared to a database containing the pre-determined optical information from an embodiment the item's identity is ascertained and the embodiment is validated as authentic.

13. The histogram data according to claim 12 are further secured by selecting and applying an arbitrary percentage to the decay lifetime measurement portion of the histogram as a unique discriminator.

14. The histogram data of claim 13 is compared to a database containing the pre-determined values for a match to authenticate the identity.

15. An identity, verification and authentication system, an embodiment comprising a subset of three or more from a population of more than three inorganic phosphorescent crystals having different optical measurements, installed within an object's structure or in a suitable compound or binder upon the surface of the object, from which the subset of crystals when assayed for optical characteristics after application of incident energy source(s) conducive to their acceptable absorption and upon the energy source(s) subsequent removal, the crystals luminesce whereby the subset combination of like crystals' and different crystals' emitting wavelengths' values together with their respective decay lifetimes' values are data collected in histograms used to establish a unique identity scheme, where decay lifetime values are further secured whereupon the application is dissected into multiple embodiments including various phosphorescent crystals, one or more in each embodiment in a distinguishable set of individual embodiment marks in a non-contiguous format of asymmetric three dimensional design or a symmetric design such as a barcode design, wherein photon emission from each mark can be machine read omnidirectional and the combination of measured decay lifetime values machine read from all marks within a predetermined area one half millimeter or greater are used for final data identity comparison.

16. The invention of claim 15 comprises one or more embodiments that occupy a physical area greater than one hundredth square millimeter and less than twenty five square millimeters.

17. The invention of claim 15 wherein different crystals' emitting wavelengths' values together with their respective decay lifetimes' values are data collected in histograms for each like type crystal population and are used to establish a unique identity scheme.

18. The histogram data according to claim 17 are further processed adding another layer of security by the user's selection of an arbitrary percentage as a factor for multiplication of the decay lifetime measurement portion of the histogram, the product of which is used in combination with the wavelength data of the histogram to establish the unique identity.

19. The histogram data of claim 18 inclusive of wavelengths and decay lifetimes are compared to a database containing the pre-determined values for a match to authenticate the identity.
